(19) United States
(12) Patent Application Publication
(10) Pub. No.: US 2003/0078851 A1
(43) Pub. Date: Apr. 24, 2003

(54) Real-time sale system and method

(75) Inventor: Su-Hei Weng, Taipei (TW)

Correspondence Address: LOWE HAUPTMAN GOPSTEIN GILMAN & BERNER, LLP, Suite 310, 1700 Diagonal Road, Alexandria, VA, 22314, US

(73) Assignee: WEB POINT CO., LTD.

(21) Appl. No.: 09/983,248

(22) Filed: Oct. 23, 2001

(51) Int. Cl. G06F 17/60

(52) U.S. Cl. 705/26

(57) ABSTRACT

A real-time sale system for stores at different locations and the corresponding method. The disclosed system includes: a central server device, a first information exchange device and at least one point of sale. The system uses the central server device and the first information exchange device to send out commodity sales information to each point of sale. Each point of sale then uses a second information exchange device to establish connections with the first information exchange device, receiving the commodity sales information. A trading device is utilized to start the commodity sales information by showing such information on multimedia information displays. The commodity sales results are recorded and sent back to the central server device.

### BACKGROUND OF THE INVENTION

1. Field of Invention

The invention relates to a real-time commodity sale system and its method. In particular, it relates to a real-time commodity sale system for stores located at different places and the corresponding method.

2. Related Art

In recent years, there are different new commodity sale methods due to progress made in industries and businesses. Aside from television and computer multimedia websites as the common sales advertising systems, there is also one type of multimedia systems usually placed in convenience stores to advertise sales events. For example, cashier machines (NEC or TEC systems) used in Japanese convenience stores have a flat LCD panel for displaying images. Simple programmed image processing with slide shows or multimedia dynamic images with audio effects are employed to provide sale information to consumers.

However, most of these systems are not able to have real-time interactions with consumers or there is only one-way sale between the merchant and consumers. Therefore, the merchant often has to have a huge advertisement budget in order to achieve a specific sale target. On the other hand, when the advertised sale activity is carried out at various points of sale, it is hard for the merchant's central system to understand and control the commodity sale results at different places. Thus, it often misses the right time to adjust its sale strategies according to the feedback from the market.

### SUMMARY OF THE INVENTION

In view of the foregoing, the invention provides a real-time commodity sale system and its method.

It is another object of the invention to provide a real-time commodity sale system and its method for stores located at different places, which enables the merchant to monitor the feedback from the market at any time so as to timely adjust its sale strategies. Thus, the invention can help the merchant achieve the goal of good sales and high competitive power.

Pursuant to the above-mentioned objects, the invention discloses a real-time commodity sale system, which includes a central server device, which transmits commodity sale information and receives commodity sale results; a first information exchange device, which connects to the central server device to transmit the commodity sale information and the commodity sale results; and at least one point of sale, which connects to the first information exchange device to receive the commodity sale information transmitted from the central server device and to transmit the commodity sale results to the central server device. The point of sale contains: a second information exchange device, which connects to the first information exchange device to transmit the commodity sale information and the commodity sale results; at least one trading device, which starts the commodity sale information; and a multimedia information processing display, which connects to the second information exchange device and at least one trading device to store the commodity sale information of the central server device, to display the commodity sale information to customers when the trading device starts the commodity sale information, and to record the commodity sale results.

Furthermore, with a point of sale connecting to a central server device using a first information exchange device, the disclosed real-time commodity sale method includes the steps of: using a second information exchange device to connect to the first information exchange device for transmitting the commodity sale information sent from the central server device; using a multimedia information processing display to connect to the second information exchange device for receiving and storing the commodity sale information; using at least one trading device to generate a start signal; using the multimedia information processing display to start the commodity sale information after the start signal is received, and displaying movable selection frame and a plurality of commodity sale images on the information display panel of the multimedia information processing display, where the inner border of the movable selection frame coincides with the outer border of each of the commodity sale images and the movable selection frame can move one the plurality of sale images; and using the selection device of the multimedia information processing device to generate a signal so that a commodity sale result is produced when the inner border of the movable selection frame coincides with the outer border of one of the commodity sale images.

### BRIEF DESCRIPTION OF THE DRAWINGS

The present invention will become more fully understood from the detailed description given hereinbelow illustration only, and thus are not limitative of the present invention, and wherein:

FIG. 1 is a schematic view showing the connection between several points of sale and a central control unit according to the invention;

FIG. 2 is a schematic view showing the sale system at each point of sale;

FIG. 3 is a schematic view showing a commodity sale screen on the multimedia information processing display at each point of sale; and

FIG. 4 is a flowchart of the disclosed sale method.

### DETAILED DESCRIPTION OF THE INVENTION

Based upon the above-mentioned objects and to conquer the drawbacks in the traditional one-way commodity advertising methods, the real-time commodity sale system of the invention mainly includes: a central server device, a first information exchange device and at least one point of sale. The merchant can use the system to monitor the market reaction and trend and properly adjusts its sale strategies.

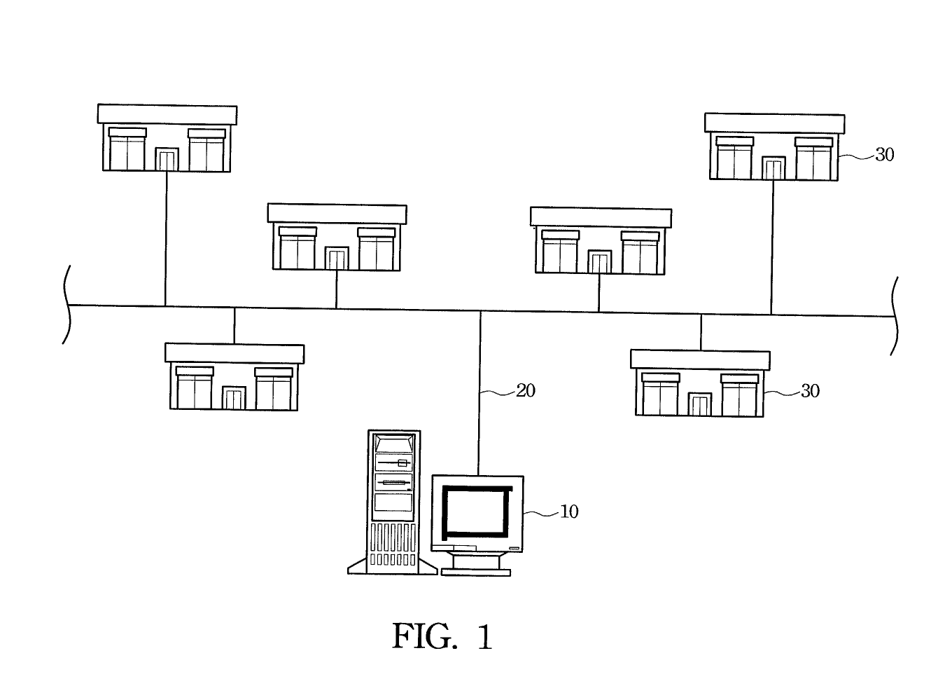

As shown in FIG. 1, the central server device 10 represents the server of a central control unit to enable the commodity merchant to send various kinds of commodity sale information to several points of sale 30 via the first information exchange device 20 and to receive the real-time sale results from each of the points of sale 30. The first information exchange device 20 is a communications system linking the central server device 10 and the points of sale 30 to transmit commodity sale information and commodity sale results. In an embodiment of the invention, the first information exchange device 20 can be the usually PSTN (Public Switched Telephone Network) or other online systems connecting to the Internet. Any system that can transmit commodity sale information can be the first information exchange device of the invention.

Furthermore, the points of sale 30 can be any normal real stores, such as convenience stores, supermarkets, wholesale markets, department stores, or retail stores that can provide consumers places to go shopping. The difference from the conventional ones is that the points of sale 30 links to the central server device 10 of the control center via the first information exchange device 20. Therefore, they can receive the latest commodity sale information transmitted from the central server device 10 at all times and transmit commodity sale results back to the central server device 10 immediately without any person to install the commodity sale information to the commodity sale system at each point of sale.

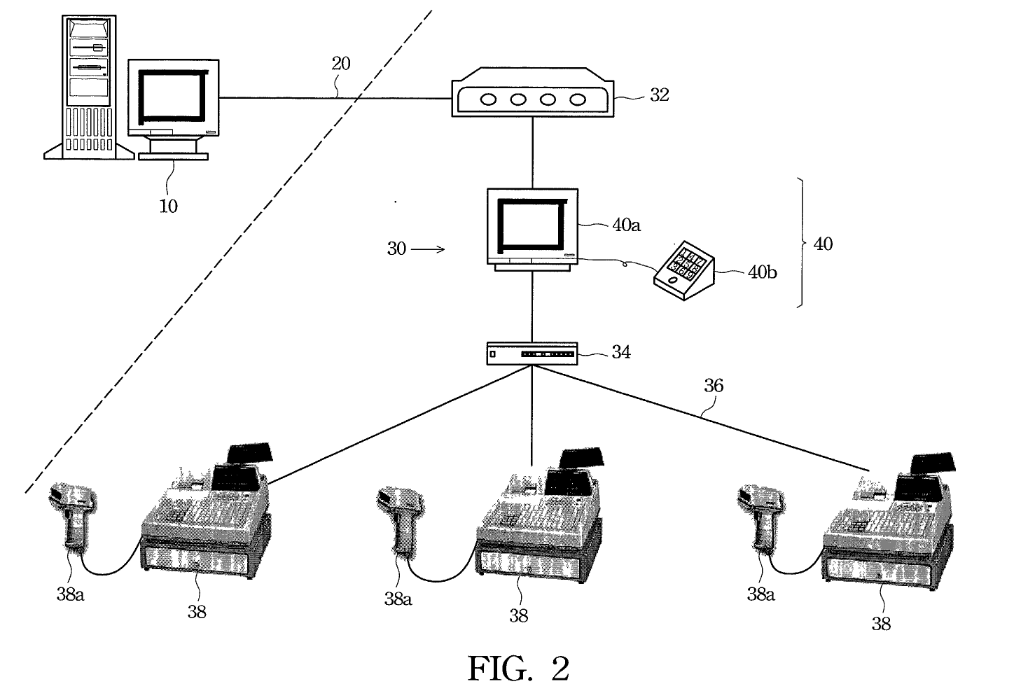

In particular, each point of sale 30 includes each of the main components shown in FIG. 2, including a second information exchange device, a trading device, and a multimedia information processing display. The second information exchange device is an internal communication device at each point of sale and connects to the first information exchange device 10 to transmit the commodity sale information and the commodity sale results. In an embodiment of the invention, the second information exchange device can be any internal network connection device. Any device that can establish a connection with the Internet and receive transmitted data can be the second information exchange device of the invention. For example, the second information exchange device can include a modem 32, a hub 34, and a 10BaseT network structure 36 or a 10Base2 network structure (not shown).

In addition, each point of sale 30 includes at least one trading device 38 to start the commodity sale information. In an embodiment of the invention, the trading device 38 can be a cashier machine or any trading platform between the store and consumers. Taking the cashier machine as an example, when the store at the point of sale trades with a consumer, the store usually use a bar code scanner 38a connecting to the cashier machine 38 to scan the bar code on the commodity package that the consumer wants to purchase and to record the name, quantity and charge for the commodity. The merchant takes the bar codes on different commodity packages as the commodity sale information code for starting the commodity sale activity. That is, after the bar code scanner 38a of the cashier machine 38 scans the bar code of a commodity, a commodity sale starting information is produced if the scanned commodity is one of the sale items. The starting information includes a commodity sale information code, a cashier machine number and a consuming serial number. The starting information is transmitted to a multimedia information processing display 40 to start the commodity sale information.

It should be noted that the bar code on the commodity package and bar code scanner form only an example for starting a commodity sale activity and should not be used to limit the invention. Other equivalent changes or modifications should be also included in the disclosed spirit and scope of the invention. For instance, the commodity sale information code of the starting information can be set as a minimum sale amount, e.g. $50, for the cashier machine to start the commodity sale activity. Or, any consumption in the store can start the sale activity. The starting criteria for the commodity sale information code can be properly adjusted according to the actual needs of the storeowner. Any condition that can serve to start a specific sale activity should be included in the scope of the commodity sale information code of the present invention.

The multimedia information processing display 40 connects to the second information exchange device and at least one trading device 38 to store the commodity sale information, from the central server device 10, and to start some commodity sale information after receiving the starting information, transmitted from the trading device 38. The starting information contains a commodity sale information code, a cashier number and a consuming serial number in order to correctly start the relevant commodity sale. For example, when some merchant wants to sell commodity A, then he can choose to enable the bar codes of a series of related commodities to start the starting information of the commodity A. The sale information code in the starting information of commodity A makes the multimedia information processing display 40 provide the sale information of commodity A to consumers to continue subsequent sale activities.

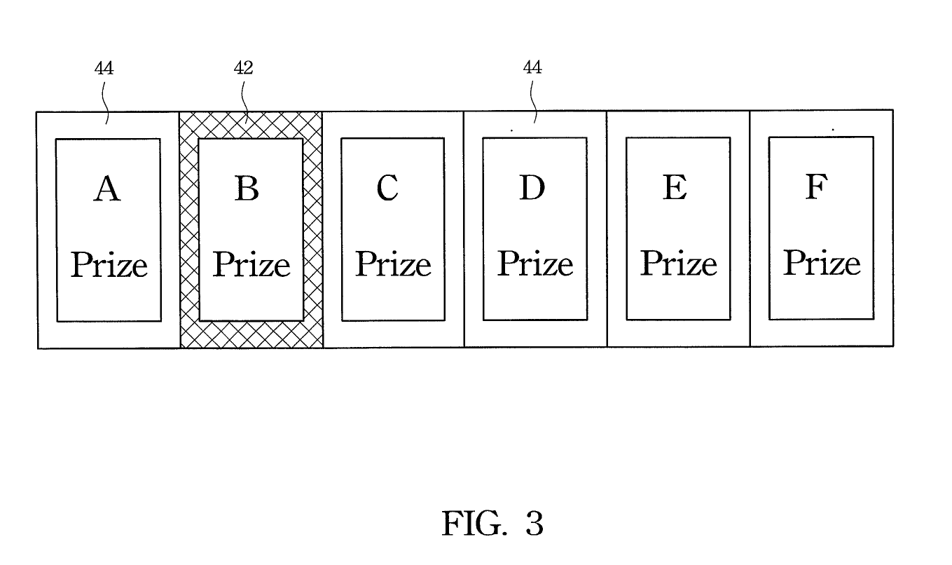

As described before, the multimedia information processing display 40 further contains an information processing device (not shown), an information display device 40a, and a selection device 40b. The information processing device starts some commodity sale information after receiving the starting information, transmitted from the trading device 38, and displays the commodity sale information on the information display device 40a. The information processing device can be, for example, a data processor of a personal computer or industrial computer. The information display device 40a can be, for example, a usual monitor, such as a CRT, a LCD or a plasma display. The commodity sale information displayed on the information display device 40a is a screen with a movable selection frame 42 and images of several sale items 44, as shown in FIG. 3. With reference to FIGS. 2 and 3 simultaneously, the inner border of the movable selection frame 42 can coincide with the outer border of each of the sale item image 44 and can move forward and backward among the images 44. When a customer uses the selection device 40b, e.g. pressing one of the buttons or at least one number key of the selection device 40b, the selection device 40b generates a signal according to random number generation and lottery probability set by the merchant so that the movable selection frame moves among the images until finally coincides with the outer border of one of the sale item images. The sale result is then shown in the information display device 40a, showing the customer which prize he has won. Accordingly, the sale effects are enhenced.

In particular, the above-mentioned sale activity is only one embodiment of the invention. One can use the invention to perform various sale activities, as shown in the following five embodiments. It should be emphasized that these embodiments are only examples to disclose the features of the invention but should not be regarded to limit the invention.

Sale model 1: If a merchant A want to promote a series of new products, a sale activity according to those new products can be held. When a consumer purchases some commodity the merchant A, the corresponding new product sale information of the merchant A is initiated and the sale activity is performed according to the above-mentioned method. After the multimedia information processing display 40 displays a prize, the prize is then granted to the consumer. Through such lottery-like sale activity, the invention can increase consumers' interest and understanding on new products. Thus the goal of promoting new products is achieved.

Sale model 2: The method is to have brand education to the public. That is, if one wants to enhance consumers' impression about new products of a particular new brand or trade mark, a plurality of commodity sale images 44 of the new brand can be arranged on the screen of the multimedia information processing display 40. When the commodity sale information is started, the consumer can use the number keys of the selection device 40b to select. If the consumer selects the correct number, a trial commodity of the brand is granted to him.

Sale model 3: This method encourages customers' consumption. That is, the merchant can set a certain purchase balance threshold to start the starting information. If a customer's consumption is greater than the certain purchase balance threshold, the sale item images 44, shown on the multimedia information processing display 40, can then show some on-sale items or discount deals.

Sale model 4: Similar to market survey, one can have interactive commodity marketing. Whenever a consumer purchases a series of new products from a merchant, the new product sale information is started to show the series of new products in the sale item images 44. The consumer can then enter how he likes the new products through the number keys in the selection device 40b. Afterwards, some commodity is granted to the consumer, achieving the interactions and commodity advertisements between the merchant and consumers.

Sale model 5: Traditionally, if a company uses a new brand name for his products, it is often difficult for the company to introduce the new brand. The interactive sale activity of the invention can overcome the difficulty because the game-like sale activity of the invention is not only able to enhance the consumer's interest on the new brand products but also a better understanding.

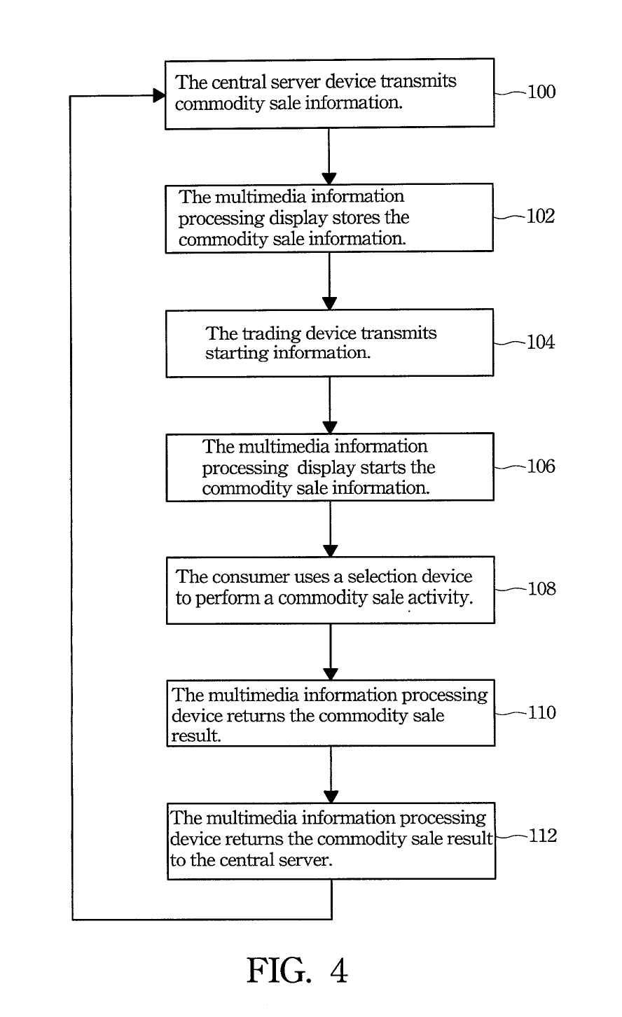

In addition, the information processing device in the multimedia information processing display 40 can record each commodity sale result, including the commodity name, the quantity, the cashier machine number, the consuming serial number, the location of the point of sale, the market survey result, etc. Aside from being used for the point of sale or central control unit to check the stocking, such real-time market information can also be sent back to the central server device 10 in the central control unit through the first information exchange device 20 to provide the latest market reaction to the merchant. The merchant can thus make necessary adjustments to the marketing strategies in accordance with the sale results and consumer reactions. The corrected commodity sale information is then immediately sent to each point of sale 30 through the first information exchange device 20 to increase the sale effects. The invention thus overcomes the lack of interactivity in traditional sale methods. In summary, with reference to FIG. 4, the disclosed commodity sale method includes the following steps:

Step 100: Use the central server device of the central control unit to generate commodity sale information, which is sent to at least one point of sale through a first information exchange device.

Step 102: A second information exchange device at each point of sale receives the commodity sale information and the commodity sale information is stored in the multimedia information processing display at each point of sale.

Step 104: When a consumer at a point of sale trades with a store through a trading device, transmitting starting information to the multimedia information processing display is triggered when the bar code of a specific sale item is scanned or the balance of the trade is over a certain threshold.

Step 106: The multimedia information processing display receives the starting information and starts the sale information of some commodity via a commodity sale information code to display the information on an information display device.

Step 108: The consumer uses a selection device, such as buttons or number keys, to perform a commodity sale activity.

Step 110: The multimedia information processing device stores the commodity sale result for the point of sale to check the sale result and sale item stocking quantity at all times.

Step 112: The multimedia information processing device returns the commodity sale result to the central server device of the central control unit to provide the merchant the real-time sale result for the merchant to modify the sale information and strategies.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A real-time commodity sale system, which comprises:
a central server device, which transmits commodity sale information and receives commodity sale results;
a first information exchange device, which connects to the central server device to transmit the commodity sale information and the commodity sale results; and
at least one point of sale, which is a commodity trading center connected to the first information exchange device to receive the commodity sale information transmitted from the central server device and to transmit the commodity sale results to the central server device, the point of sale including:
a second information exchange device, which connects to the first information exchange device to transmit the commodity sale information and the commodity sale results;
at least one trading device to start the commodity sale information; and
a multimedia information processing display, which connects to the second information exchange device and the trading device to store the commodity sale information from the central server device, to display the commodity sale information to a consumer after the trading device starts the commodity sale information, and to record the commodity sale results.

2. The system of claim 1, wherein the point of sale is selected from the group consisting of convenience stores, supermarkets, wholesale markets, department stores, or retail stores and their combinations.

3. The system of claim 1, wherein the trading device further comprises a cashier machine which generates a starting information sent to the multimedia information processing display to start the commodity sale information when trading sale commodities.

4. The system of claim 3, wherein the starting information includes a commodity sale information code, a cashier machine number and a consuming serial number.

5. The system of claim 4, wherein the commodity sale information code includes a bar code of the sale commodity.

6. The system of claim 4, wherein the commodity sale information code includes a starting condition of being above a certain purchase balance threshold.

7. The system of claim 4, wherein the commodity sale results further include the sale commodity, the cashier machine number and the consuming serial number.

8. The system of claim 3 with the multimedia information processing display further containing an information processing device, an information display device and a selection device; wherein the information processing device starts the commodity sale information after receiving the starting information and shows on the information display device a movable selection frame and a plurality of sale item images, the inner border of the movable selection frame coinciding with the outer border of each of the sale item images and being able to move among the sale item images; the consumer uses the selection device to generate a signal so that the inner border of the movable selection border coincides with the outer border of one of the sale item images, giving the commodity sale results.

9. The system of claim 8, wherein the selection device further contains a button, which when depressed generates a random number to move the movable selection frame until the inner border of the movable selection frame coincides with the outer border of one of the plurality of sale item images.

10. The system of claim 8, wherein the selection device further contains a plurality of number keys to select and move the movable selection frame until the inner border of the movable selection frame coincides with the outer border of one of the plurality of sale item images.

11. The system of claim 1, wherein the first information exchange device further comprises an Internet connection system.

12. The system of claim 1, wherein the second information exchange device further comprises an Intranet connection system.

13. A real-time commodity sale method for applications at points of sale which connect to a central server device using a first information exchange device, the method comprising the steps of:
using a second information exchange device to connect with the first information exchange device for transmitting commodity sale information from the central server device;
using a multimedia information processing display to connect to the second information exchange device for receiving and storing the commodity sale information;
using at least one trading device to generate starting information;
using an information processing device of the multimedia information processing display to start the commodity sale information after receiving the starting information, displaying a movable selection frame and a plurality of sale item images on an information display device of the multimedia information processing display, the inner border of the movable selection frame coinciding with the outer border of each of the sale item images and being able to move among the plurality of sale item images; and
using a selection device of the multimedia information processing display to generate a signal so that the inner border of the movable selection frame eventually coincides with the outer border of one of the plurality of sale item images, thus generating a commodity sale result.

14. The method of claim 13, wherein the step of using the trading device to generate the starting information further comprises the step of using a cashier machine to generate and send the starting information to the multimedia information processing display during a commodity trade.

15. The method of claim 14, wherein the starting information includes a commodity sale information code, a cashier machine number and a consuming serial number.

16. The method of claim 15, wherein the commodity sale information code is generated by using a bar code scanner to scan the bar code of a commodity for sale.

17. The method of claim 15, wherein the step of generating commodity sale information code includes the step of using the cashier machine to accept a trade over a certain balance threshold.

18. The method of claim 13, wherein the step of using the selection device further comprises the step of using a button to generate a random number for moving the movable selection frame until the movable selection frame slows down and finally it inner border coincides with the outer border of one of the plurality of sale item images.

19. The method of claim 13, wherein the step of using the selection device further comprises the step of using a plurality of number keys to select and move the movable selection frame until the movable selection frame slows down and finally it inner border coincides with the outer border of one of the plurality of sale item images.

20. The method of claim 13 further comprising the step of using the information processing device to record the commodity sale result.

21. The method of claim 20 further comprising the step of using the information processing device to transmit the commodity sale result to the central server device through the second information exchange device and the first information exchange device, analyzing the commodity sale result and adjusting the commodity sale information in real time.

22. The method of claim 13 further comprising the step of using an Internet connection system as the first information exchange device.

23. The method of claim 16, wherein the second information exchange device further utilizes an Intranet connection system to connect to the first information exchange device.
